(19) United States
(12) Patent Application Publication
(10) Pub. No.: US 2003/0219708 A1
(43) Pub. Date: Nov. 27, 2003

(54) Presentation synthesizer

(75) Inventors: Angel Janevski, New York, NY (US); Thomas McGee, Garrison, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/155,262

(22) Filed: May 23, 2002

(51) Int. Cl. G09B 3/00

(52) U.S. Cl. 434/350; 434/118; 434/322; 434/362

(57) ABSTRACT

Customizable multimedia content is transmitted in a form where some content is described by content descriptors. The content descriptors are used in the receiving device to synthesize a final version of the content. Content descriptors may include information relating to content length, expecting user mood, expected user location, content type, expected time of day of receipt, expected display device, and/or language in which the content is described. Local information may be used to inform the synthesis process. Local information may include user preferences generated from a user profile, context information detected automatically, or user preferences entered manually by a user. Alternatively, some synthesis instructions may be part of the content descriptors. Synthesizing creates a presentation of the content which may include a synthesized person, a cartoon character, an animal, a talking object, text, and/or audio.

### BACKGROUND OF THE INVENTION

A. Field of the Invention

The invention relates to the field of customization of transmitted content.

B. Related Art

A certain amount of work has been done, for instance in WO 01/52099 and US 2001/0014906, relating to overlaying transmitted video content with substitute content to create a customized final show for user viewing.

These systems have the shortcoming that the overlaid content will generally not fit very well into the existing content, and the result may look pieced together, awkward, or cartoonish. Another disadvantage of the prior art systems is that transmitted information requires high bandwidth channels.

### SUMMARY OF THE INVENTION

It is advantageous to transmit at least part of a piece of content in the form of content descriptors with presentation elements being synthesized at the receiver end.

The receiver end may include means for gathering local information useful for choosing presentation elements.

Various types of local information may be used to inform content synthesis. These may include user profile information, context information, and/or direct user input.

Various types of presentation elements may be used, such as synthesized: people, cartoon characters, animals, objects, text, and/or audio.

Content descriptors may include information about: content length, user mood appropriate to the content, location appropriate to experiencing the content, content type, time of day appropriate to experiencing the content, language in which the content is expressed, and/or a display device type appropriate to displaying the content.

Objects and advantages will become apparent in the following.

### BRIEF DESCRIPTION OF THE DRAWING

The invention will now be described by way of non-limiting example with reference to the following drawings.

FIG. 1 shows a system in which the invention may be implemented.

FIG. 2A-1 shows content descriptors.

FIG. 2A-2 is a schematic of a photograph to be transmitted as a content descriptor.

FIG. 2A-3 is a schematic of an alternative photograph to be transmitted as a content descriptor.

FIG. 2B shows an example of a specification of content flow which may be transmitted with content.

FIG. 2C shows a content segment description.

FIG. 3 shows a block diagram of operation of an embodiment of the invention.

FIG. 4 shows a flow chart.

### DETAILED DESCRIPTION OF THE PREFERRED EMBODIMENTS

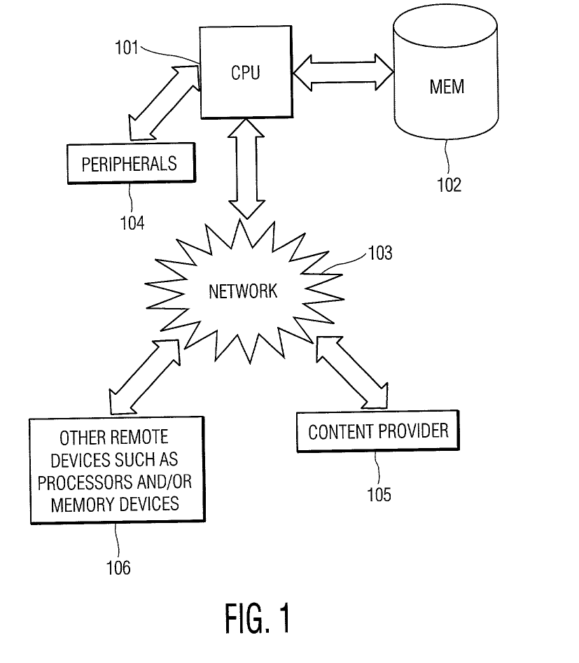

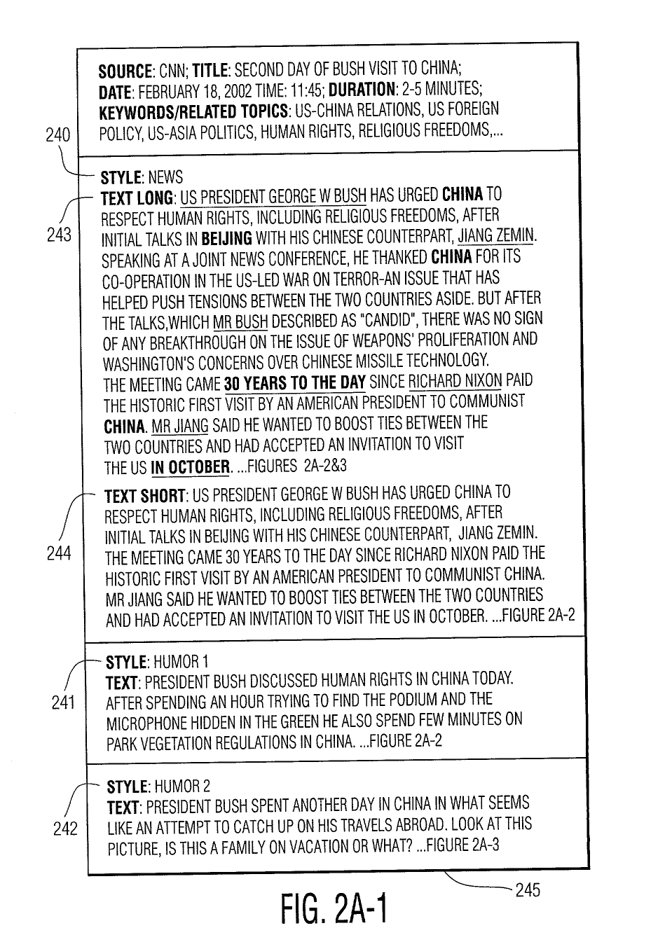

FIG. 1 shows a system suitable for implementing the invention. The system includes local CPU 101, a memory 102, and peripherals 104, connected via network 103 to at least one remote content provider 105 and other remote devices 106.

The CPU may be of any suitable type, such as is found in a PC or set-top box or such as a signal processor. There may be a single CPU, or several CPUs.

The memory 102 may also be of any suitable type, such as electronic, magnetic, or optical and may be housed together with the CPU or separately. Typically there will be several memory devices, such as an internal RAM, a hard drive, a floppy disk drive, a CD/RW, a DVD player, a VCR, and/or other memory devices.

The peripherals 104 will typically include devices for communicating with the user or for sensing context. Devices for communicating with the user may include a display, a printer, keyboard, a pointing device, a voice recognition device, a sensor for receiving communications from a remote control, a speaker, etc. Devices for sensing context may include a camera, a microphone, an IR sensor, a clock, an indoor/outdoor thermometer, a sunshine detector, a humidity detector, and so forth. Devices for communicating with the user may also be viewed as devices for sensing context.

The network 103 may be a broadcast network, a cable network, the Internet, a LAN, or any other network. The CPU 101 may actually be connected to several networks at once, or may use one network to communicate with other networks. The network connection may be used to communicate with other devices such as CPUs, memories, or peripherals 105 or to communicate with a content provider 106.

Content description

Content to be used in the invention normally should arrive from a provider 105 annotated and with sufficient information to allow for customization on the client end. The content may, but need not, include traditional video information. Instead, much of what is transmitted will be merely a description, i.e. “content descriptors”. Content descriptors may also be thought of as metadata. The content descriptors describe the final content version that is to be presented but do not contain, the final content version in its entirety. Content descriptors require synthesis of presentation information on the receiving end before a viewable “show” or “program” may be achieved. The term “final content version” will also be used herein to describe the result of the Is synthesis.

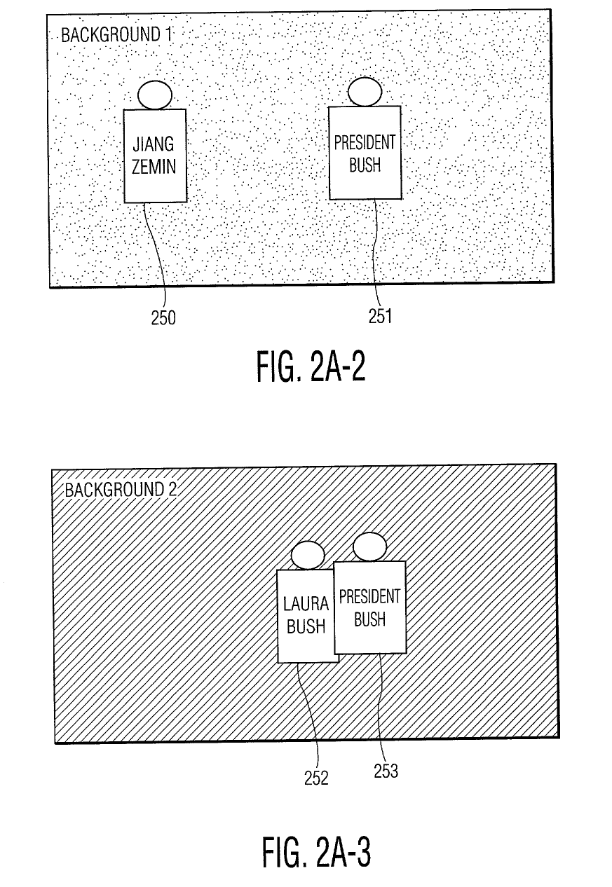

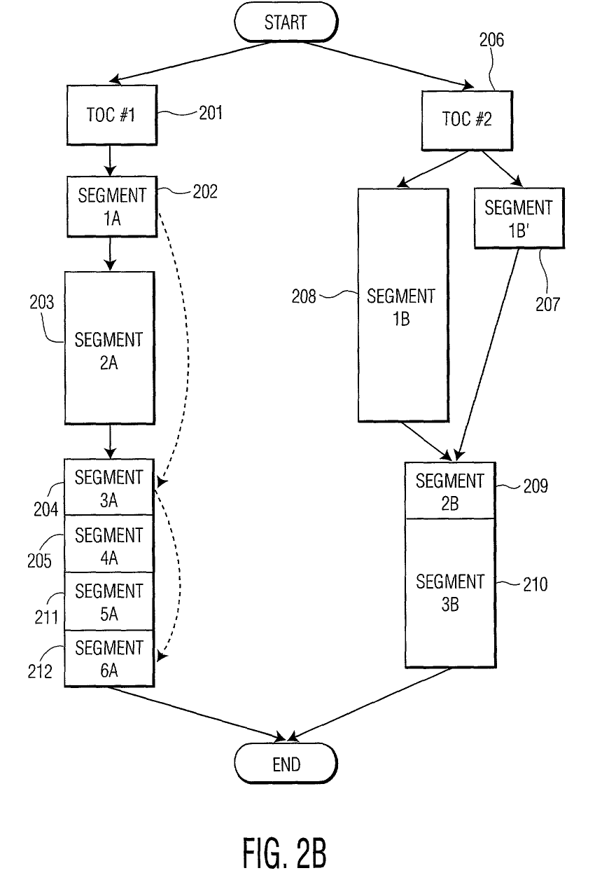

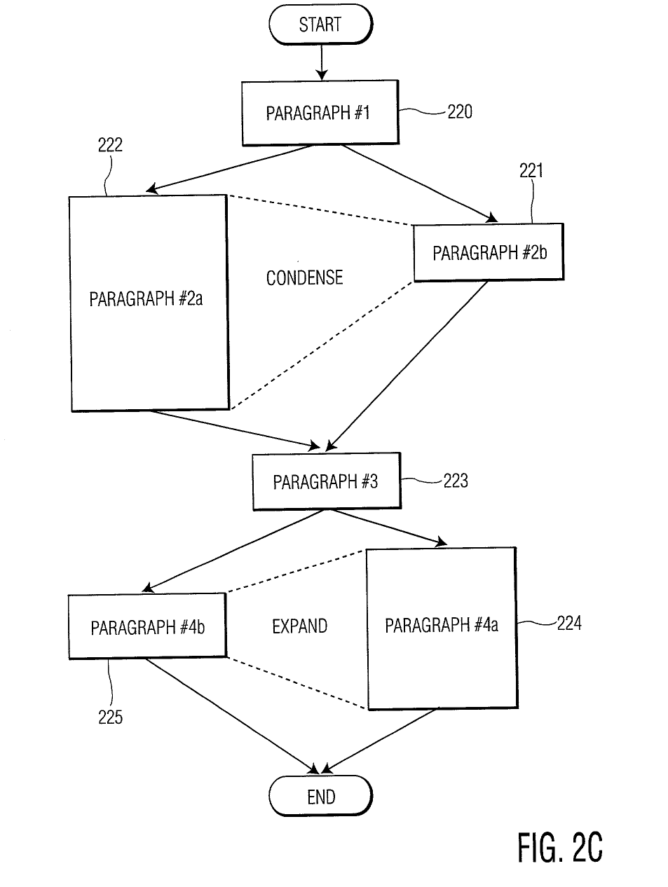

At least some of the content descriptors will typically be text-like; but the content descriptors may also contain multi-media data such as still photos, video clips, and music, which are to be incorporated into the final content version. FIGS. 2A-1-3; 2B; and 2C give examples of content descriptors that might be transmitted. The story of FIG. 2A-1 comes in several versions: news (240), humor 1 (241), and humor 2 (242). One of the versions, news, has sub-versions for alternate presentations. The illustrated sub-versions are: text long (243) and text short (244). More alternative versions and sub-versions could be presented. Tags may be embedded to annotate significant features of the show such as:

the “punch line of the segment (story)”;

the main protagonists of the segment—e.g. President Bush, or the name of a movie character;

time, place, event sections—so that the client can use its own processing to generate yet another version of the segment or paragraph;

personality descriptions—e.g. a peripheral character in a series for which the user states general preferences (male/female, young/old, . . . ); or

setting—e.g. news outdoors/indoors, past/present/future, for instance to allow a soap opera to be set in the 16^{th} or 22^{nd} century.

Those of ordinary skill in the art may devise any number of other features that may be provided as content descriptors and/or tagged to allow customization. Tags may also be considered as a type of “content descriptor.” The descriptors include a header 245.

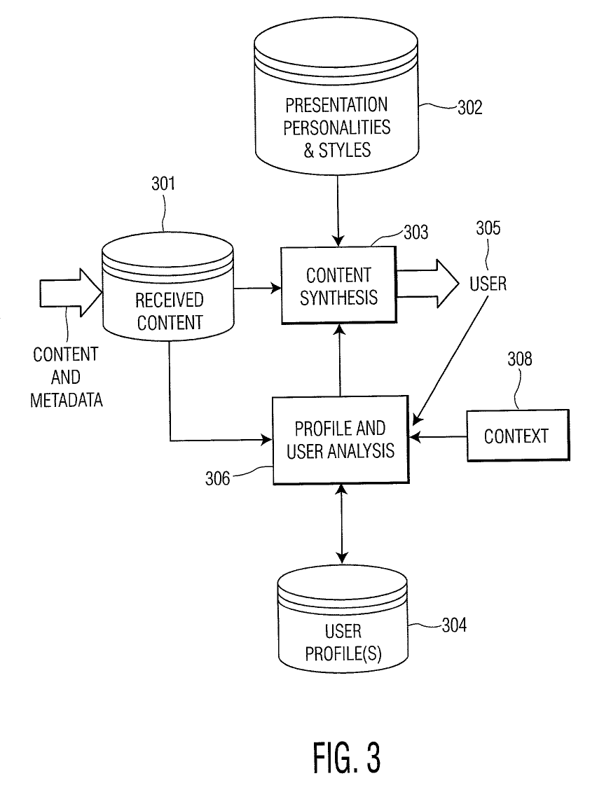

In addition to different versions of the text, multimedia information may be sent as part of the content descriptors. For instance, FIG. 2A-2 is a schematic of a photograph. The details of the photograph are not shown in order to simplify the drawing. The photograph may be transmitted in its entirety or parts may be described by content descriptors. The photograph includes two human figures 250 and 251—e.g. President Bush speaking with a Chinese leader—and a background, designated as “Background 1”—for instance a park. FIG. 2A-3 shows a schematic of an alternative photograph. Again the details of the photograph are omitted to simplify the drawing. This photograph shows a different pair 252 and 253 of human figures against a different background, designated as “Background 2.” In this example, the alternative photograph may show President and Mrs. Bush in front of the Great Wall of China.

Referring back to FIG. 2A-1, it can be seen that the long version of the news uses both photographs, FIG. 2A-2 and 2A-3, referring to both the political meeting and the touristy side of the trip, while the short version uses only the first photograph, FIG. 2A-2. The first humor version also uses only the first photograph, FIG. 2A-2; while the second humor version uses only the second photograph, FIG. 2A-3.

FIG. 2B shows a flow description for content descriptors for a piece of programming. Normally this type of flow description would be transmitted before the detailed information of FIG. 2A-1 through 2A-3 to simplify processing and help the receiving device anticipate what is coming. This particular flow diagram is just an example. It does not necessarily relate to the particular descriptors of FIG. 2A 1-3. FIG. 2B illustrates a piece of programming that can result in two general versions (A and B) of the same content.

The receiving device preferably uses these flows to determine which parts of the data to use. The data and flows may be used more than once. For example, at 10:00 AM, the user might get the latest episode of the television series to be synthesized immediately for watching as a 20 minute short version. Then, the same content, which may be stored on the receiving device, can be reused generate a one hour version over the weekend.

In FIG. 2B, tables of contents 201 and 206 are transmitted first and explain the versions of the programming before they arrive. The A flow—on the left—contains 6 segments 202, 203, 204, 205, 211, 212, which have to be presented in order; except that for a short version of the entire show, the system can skip segments 2A (203); 4A (205) and 5A (211). The B flow—on the right—has only 3 segments 207/208, 209, and 210. The B flow allows segment 1B to be presented in two versions: the long segment 1B (208) and the short segment 1B′ (207). The alternatives shown at 208 and 207 are analogous to the long and short versions shown at 243 and 244 in FIG. 2A-1.

Each segment can also have a complex structure. FIG. 2C shows a segment that contains 4 paragraphs 220, 221/222, 223, 224/225. These “paragraphs” can also be thought of as sections or sub-segments. The flow is mainly linear, but there can be multiple presentations based on processing that occurs in the receiving device (locally) and is based on the content and the presentation style.

The segment/paragraph structure can improve processing efficiency, by reducing the number of choices that the receiving device needs to evaluate. For instance, if the content is a news program, each segment might be a news story. First, the receiving system chooses which news stories are of interest. Then the receiving system can process options within each story. In that way the receiving system avoids processing all options within all stories. More or less levels of choice structure might be implemented by the skilled artisan according to design choice.

For example, suppose the segment is a 3-minute car-chase from a thriller movie. Paragraph 1 (220) can be a 30 second part where a police car spots a fast-moving car and starts chasing it. Paragraph 2 (222) can be a 1 minute 30 second part where the two cars make dramatic passes through several (e.g. 6) intersections. If the user preferences say that car-chases and/or violence are not appreciated, then the device could generate a shorter version (221) of this paragraph where two representative, i.e. annotated, moments of the car chase are given in 20 seconds. Then, in paragraph 3 (223), there is a collision of the police car with another vehicle, which stops the chase. In paragraph 4 (225), the fast-moving car escapes. For car-chase lovers, for example, paragraph 4 could be expanded (224) from 30 seconds to 2 minutes by generating more dramatic moments of the escape, e.g. driving through a mall, a crowded marketplace, or the like.

In another example, let's suppose that the segment is the introductory part of a talk show. The left hand side of FIG. 2C could be viewed as an “original” version, while the right hand one could be a special version, adapted to a particular personality style that might be selected at the receiver end. This personality style might, for instance, be that of Jay Leno, a popular talk show host. If the particular personality is to be selected, some of the original version—for example, paragraphs 1 (220) and 3 (223)—may be presented without or with very little alteration in content; but other parts—such as paragraphs 2 (222) and 4 (225)—may be changed. In this example, paragraph 2 is condensed to a shorter segment (221) by using only the key parts of the document, in accordance with annotations or tags described above. Paragraph 4, on the other hand, is to be expanded to twice the length (224) by taking the original paragraph and adding more words in the desired personality “style”. These additional words might be acquired from the current transmission or from other sources, such as the Internet or local files of stored content. For example, if this is the story about the President visiting China, the preferred talk show host could “spice” it with an introduction like: “You'll love this story—I just love stories about the President. Just like the <related event from earlier show>”. The operator in triangular brackets would then allow the system to go out and search the Internet or other sources to find the requested information.

The data formats in FIGS. 2A1-3, 2B, and 2C are only examples. Data could equally well be transmitted in the form of tables or other data formats. Content can be synthesized to substitute parts of the original content or to entirely replace it. The received content can be encoded in formats that allow for specific components of it to be dropped and other components to be added. Suitable formats include MPEG-4,

http://mpeg.telecomitalialab.com/standards/mpeg-4/mpeg-4.htm; and MPEG-7,

http://mpeg.telecomitalialab.com/standards/mpeg-7/mpeg-7.htm. These standards enable encoding of the content that would enable description of individual objects and scenes that can be partially or completely replaced with alternatives.

A content descriptor version of a show may be transmitted in parallel with an original show. This might be achieved by using a different television channel or by a separate Internet version. The user would then have the choice of choosing the conventional show or the content descriptor version, which allows for synthesis.

Alternatively, a service might transmit all the versions together.

Processing of Received Content Descriptors

Once the content descriptors are received at the receiver, a presentation is to be synthesized to give a resulting final content version. Such synthesis is to be personalized. Such personalization may be based on a number of things such as one or more of: tags indicating style selection from the transmitter end, stored user preferences, interactive user choice designations, and detected context.

The “presentation” that is to be synthesized may include various aspects of the resulting program such as:

one or more presenting figures or media—such as a human being, cartoon character, animal, talking object, text and/or audio;

background video; and/or

presentation styles such as: news, humor, short, or long.

FIG. 3 shows a system for implementing content synthesis 303 based on transmitted information 301, a user profile 304, context sensing 308 and personality and/or style data 302. The system of FIG. 3 may be implemented in software or hardware. Processing may also be distributed amongst more than one processor and/or memory.

The transmitted information as described with respect to FIGS. 2A through 2C is stored in a database 301.

The context sensor 308 will normally have peripherals (not shown) such as a camera, a microphone, an IR sensor for use with a remote control, weather sensing devices, user mood sensing devices, a clock, a keyboard, and/or a pointing device. Box 308 may do some processing to integrate the various sensed contexts into some whole context format, or it may simply be a collection of more traditional hardware connections from sensing devices into a processor. The context sensing devices will typically perform their traditional functions in addition to gathering information relevant to what content is to be synthesized. Those of ordinary skill in the art may use more or less devices, or devices of different types. The context sensor provides context information to the profile and user analysis unit 306.

User Preferences

The profile and user analysis unit 306 interacts with a user 305 to build a profile database 304. The interaction with the user 305 can take many forms. For instance, it can make use of the context sensing devices 308. Or it can interact with the user by automatically recording viewing behavior to help build the database.

The profile and user analysis unit 306 also functions to integrate local information such as context end-user choices with the profile database to make style selections. The style selections are then fed to the synthesis unit 303 to inform content synthesis. For example, suppose the context and user mood determine that the weather is to be presented by a comedian. Then the question becomes which it is, a synthesis of some real person that the viewer likes or some artificial character. The answer to this question must be answered by user analysis.

One way to implement taking into account the user preferences is to have a user profile 304. This profile can contain information allowing the profile and user analysis unit 306 to determine the type of content the viewer likes, such as, comedies, CNN news, work location, home location, preferences at time of day, etc. Some examples of using user profiles to select content can be found in U.S. patent application Ser. No. 09/466,406 filed Dec. 17, 1999, METHOD AND APPARATUS FOR RECOMMENDING TELEVISION PROGRAMMING USING DECISION TREES; and U.S. patent application Ser. No. 09/666,401 filed Sep. 20, 2000, METHOD AND APPARATUS FOR GENERATING SCORES USING IMPLICIT AND EXPLICIT VIEWING PREFERENCES, which are incorporated herein by reference.

Content Filtering

One of the functions performed by the profile and user analysis unit 306 is to filter content. Normally this will be done under the guidance of the flow diagrams of FIGS. 2B & C. Using the user profile information, the profile and analysis unit will select segments and paragraphs.

Content may be filtered according to tags in the content description, context, user preference, or user choices. Many different filtering criteria are conceivable.

Content Filtering According to Time-of-day

The peripherals may be used to detect a local time of day. This would be most useful where a transmission was sent to numerous time zones. The time of day may then be used to inform style selection.

For instance, on a workday morning, the user may want the local weather for that particular day, the relevant section of the traffic report that encompasses the route driven to work, and headlines news from CNN. The presentation could be in any number of formats, such as, on a TV by various anchors from different channels or an audio from the user's alarm clock with different soft voices.

Another scenario might occur when the user arrives home from work and tunes into the news of the day. Now the user may be interested in the five day forecast to plan a weekend. The user may also want more detailed news, not just the headlines desired in the morning. Additional topics, such as sports might be added; while other information, such as traffic may no longer be relevant.

Content Filtering According to Mood

Some of presentation styles can depend on the user's current mood, e.g. a depressed person may want to see or hear different content from a cheerful person.

One mood may cause a user to want

sports scores and highlights presented along with bloopers by a comedian;

stories about the World Trade Center terrorist attacks that have happier endings, such as someone being rescued or some of the heroic efforts, but not that it has been several days since anyone has been rescued; and

presentation by a warm trustworthy personality.

Another mood may cause the user to want the news related to the arrest and capture of the planners of the World Trade Center attack presented by a strong authoritative figure.

Content descriptors or tags may specify allowable presentation moods that are appropriate to the particular content. This type of mood specification might be made to override a local determination of the user's mood. For example, the planes flying into the World Trade Center would probably never be shown by a comedian. Nevertheless some choices of mood might be possible. For instance, the incident could be presented by an angry, authoritative figure or an innocent, naïve figure who does not understand why this would happen. The allowable moods could then be matched to the user profile and context to determine how to present the item to the viewer.

Each mood and context combination could have a respective associated content length and presentation style.

Style Choice Based on Content Descriptors or Tags

The presentation could also be based on current condition known to the broadcaster or transmitter. For instance, in a weather forecast, tags may be sent along indicating that certain presentation styles are suitable. A clear, sunny day may be represented by a calm person on a beach, while a winter storm warning could be presented by a person shivering and wearing an Eskimo outfit. In such cases, the tags could be passed to the synthesizer in place of local information to inform synthesis of the presenter figure portion of the presentation.

Presentation Personalities & Styles

Once the content is filtered and the length and presentation style are determined by the user profile and analysis unit 306, the specifics of the style can be generated by the synthesis unit 303.

The database or databases 302 contain a repository of presentation descriptors including multiple entries, to be used in content synthesis. These presentation descriptors may be acquired in any number of different ways. For instance, they may be: purchased recorded on a medium, transmitted periodically from the same source as the content descriptors, and/or downloaded on request from the same source as or a different source from the content descriptors.

There can be multiple presentation styles for each genre or even specialized presentation styles for individual shows. For example, there can be a news presentation style where the anchor is delivering the news while lying on the beach and sipping a cocktail, or on the living room stage of the viewer's favorite sitcom.

Each aspect of the presentation can be further customized. For example, if a character is driving a car, the choice of cars is limited to the available car models in the timeframe of the presentation style. For instance, if the content is supposed to be taking place in the 1970's, for consistency and realism, the cars should be cars that were manufactured during a 10 year period before then. Furthermore, the car itself can be customized according to the user's preferences (e.g. European, US, Asian model or even more specific such as a BMW).

Personalities may also modeled either as talking heads for (anchors) or full-bodied (for characters).

Synthesis

The synthesizer 303 uses the databases 302 to create synthesized content based on the transmitted information 301 and based on filtering and style selection by the profile and user analysis unit 306. The synthesizer 303 outputs a show 310.

Many different types of styles can be envisioned e.g. short story/funny, short story/serious, long story/funny, etc. The format of the style selection may be of any sort devised by the skill artisan. For instance key items requested by the content descriptors, such as length, time of day, segment choices, user requests, stored user preferences, etc., may be specified by the user profile and analysis unit. Alternatively, there may be some numerical coding scheme.

The synthesizer unit 303 can also associate personalities for presentation with the content, e.g. weather by Bozo the clown in the funny version and Bill Evans for the standard broadcast. The story would be matched to the requested style based on the key items, time of day and user likes. From here, the correct stories are then to be chosen for presentation by the appropriate personality.

The synthesizer module can contain a variety of sub-modules to facilitate synthesis that either does a partial replacement of transmitted content or which regenerates it from scratch. Examples of talking head synthesis (realistic and cartoon) can be found in Yan Li, Feng Yu, Ying-Qing Xu, Eric Chang, Heung-Yeung Shum, “Speech-Driven Cartoon Animation with Emotions,” ACM Multimedia 2001, The 9th ACM International Multimedia Conference, Ottawa, Canada, Sep. 30th-Oct. 5th, 2001; and T. Ezzat and T. Poggio, “Visual Speech Synthesis by Morphing Visemes,” MIT Al Memo No. 1658/CBCLMemo No.173, 1999.

Other types of synthesis besides talking head synthesis may be used. For instance, cartoon characters or animals may be added to present content. Content may be synthesized as text or music as well.

Several different synthesized elements may need to be combined. An example of combining different synthesized elements may be found in de Sevin et al., EPFL Computer Graphics Lab—LIG, ‘Towards Real-time Virtual Human Life Simulation,” 0-7695-1007-8/01; IEEE 2001.

Types of Content Synthesis Appropriate to a Talk Show

Talk shows may be presented in various styles. A style may include features such as the personality of a host and whether the show has interactive aspects or may be viewed passively.

For instance, the style choice by the profile & analysis unit 306 may indicate that the user likes the voice and appearance and style of David Letterman, but the guests Letterman may be having that evening may not interest this user; while the user may be very interested in the guests who are appearing on another talk show, such as Jay Leno. Using the synthesizer 303, a synthesized David Letterman may be substituted for Jay Leno, interviewing Jay Leno's guests. Because the content is described in the form of descriptors, David Letterman will not be simply pasted over Jay Leno, but rather the entire show will be re-synthesized, based on the content descriptors.

The style choice may indicate that a user wants a program to be one way or interactive depending on context. For instance, when watching alone, a person may just sit passively and consume the talk show—alternatively, if the viewer is watching with a friend, some of the program may be made more interactive—or vice versa.

The user may wish to insert pauses into the content. For instance, when the talk show host asks a question like “What happened to you at the casaba?”, some alternative content, or even dead space, may be inserted to give time for the viewers to answer among themselves before the talk show guest reveals the answer. The synthesizer could be cued to create the opportunity for user input based on tags in the content descriptors.

Types of Content Synthesis Appropriate to Sports

A sportscast may have many different style elements, such as percentage of audio or text; and/or identity of the announcer

Sports delivered to a single-viewer home may be delivered with more audio coverage and less of a textual overlay. The viewer may also select the sports announcer that he or she likes instead of the default one provided by the broadcaster. To spice up Monday Night Football, Dan Dierdorf may be substituted for by John Madden to announce along with Frank Gifford and Al Michaels. In a bar, on a large screen TV and with a noisy environment, the proprietor may select the broadcast to have a lot of text information such as player names with the highlights, so that customers can enjoy the content, without hearing it.

Narrative Content

The following example is a soap opera, but this type of synthesis can easily be extended to many narrative content formats.

Each episode and the scenes of the soap opera can be delivered in several versions. For example, some viewers can go for the shorter version where the focus is the basic story and main characters. Alternate episode versions can contain additional characters that are not crucial to the story line, but communicate different “flavors” of the show. For example, there can be an optional character—a best friend to the main female protagonist of the show. The user can either state preferences for such characters in advance (e.g. male, young, optimistic) or can do that on a by episode or by show basis. That way, the user can experience the same content expressed according to several styles and/or versions.

For example, when busy in the morning, the user watches the short version just to find out what has happened, but then in the evening, the user can pick his or her favorite settings and watch a 2-hour version of the show which only took 15 minutes to watch in the morning. The show may also be shown in versions that have different maturity ratings. A bedroom scene may have the same actors and plot but the degree of explicit content and/or nudity may be filtered by preferences.

Advertising

Advertising may also be customized to the different versions. A premium could be charged for the multiple version transmissions, because of the expectation that each version will be watched on separate occasion, due to the unique experience in each viewing setup. Moreover, a very popular personality that can be customized for a show can be used in conjunction with product placement and advertising.

Content may be personalized in many different ways. The types of personalization possible are too many to list here, so those listed above should be regarded as examples only. For instance, although the examples have been given in the form of video presentations, synthesis might result in an audio or text only presentation. The audio or text appearance can be personalized to suit the user.

Flowchart

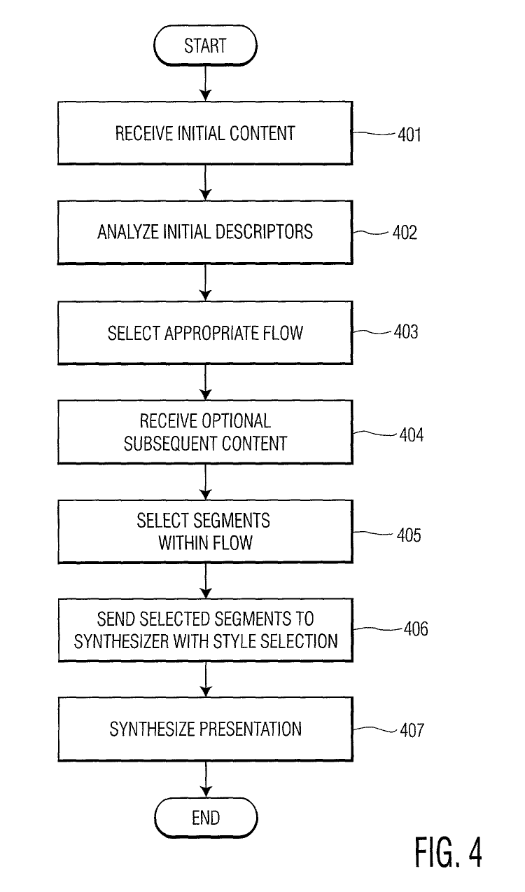

FIG. 4 shows a flowchart indicating a preferred order of operations to be performed by the device of FIG. 3. At 401, content is received from a transmitter or broadcaster. At 402 there is an initial analysis of descriptors. Then at 403 an appropriate flow is selected, as discussed with respect to FIGS. 2B, in accordance with local information, such as user profiles, context information, or interactive user selections. Then, at 404, optional subsequent contents are received. At 405, segments within the flow are selected. The selected segments are sent, at 406, to the synthesizer at 407 with a style selection made by the profile and user analysis module 306, the synthesizer synthesizes the presentation.

From reading the present disclosure, other modifications will be apparent to persons skilled in the art. Such modifications may involve other features which are already known in the design, manufacture and use of software and hardware for customizing content and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements.

1. A method of processing content comprising executing the following operations in at least one data processing device:
receiving the content wherein at least a part of the content is expressed as content descriptors;
synthesizing presentation elements responsive to the content descriptors;
outputting a resulting final content version in which the part specified by the content descriptors is presented in accordance with the synthesized presentation elements.

2. The method of claim 1 wherein
the operations further comprise gathering local information; and
synthesizing is responsive to the local information.

3. The method of claim 2, wherein
the content descriptors describe a plurality of versions of the content; and
the method further comprises selecting those content descriptors corresponding to a desired version based on the local information; and
the synthesizing uses the selected content descriptors.

4. The method of claim 3, wherein the content descriptors comprise a description of local information needed to be gathered in order to allow synthesis of at least one of the plurality versions.

5. The method of claim 3, wherein
the content descriptors require gathering of local information relating to one or more of:
desired length of presentation of at least two alternative versions;
a user mood appropriate for at least one of the plurality of versions;
a user location appropriate for at least one of the plurality of versions;
a desired content type;
a time of day appropriate to at least one of the plurality of versions;
a display device appropriate to at least one of the plurality of versions; and
a language in which at least one of a plurality of versions is presented; and
the method further comprises gathering the required local information.

6. The method of claim 3, wherein the selecting is done automatically based on stored user preferences.

7. The method of claim 3, wherein the selecting occurs responsive to a user specification of the desired version.

8. The method of claim 2, wherein the local information is derived at least in part from a user profile.

9. The method of claim 2, wherein the local information is derived at least in part from a local context.

10. The method of claim 2, wherein synthesizing comprises selecting at least one selected presentation element from amongst a plurality of alternative presentation elements.

11. The method of claim 10, wherein the at least one selected presentation element comprises a background specified in still photo information in the content descriptors.

12. The method of claim 10, wherein the at least one selected presentation element comprises text or audio presentation.

13. The method of claim 10, wherein the at least one selected presentation element is chosen automatically based on the content descriptors.

14. The method of claim 10, wherein the at least one selected presentation element is chosen automatically based on the local information.

15. The method of claim 10, wherein the at least one selected presentation element is chosen responsive to an interactive user specification.

16. The method of claim 10, wherein the at least one selected presentation element comprises one or more of
a person;
an animal;
text; and
audio.

17. Software for implementing the method of claims 1-16.

18. A processing device for implementing the method of claims 1-16.

19. A method of specifying content to be viewed comprising transmitting a content description suitable for informing synthesis of the content at a receiver end.

20. The method of claim 19, wherein the content description comprises text-like descriptors from which spoken material can be synthesized.

21. The method of claim 19, wherein the content description comprises a plurality of alternative flow specifications from which a version of the content to be viewed can be chosen for synthesis.

22. The method of claim 19, wherein the content description comprises style type alternatives from which a style of content to be viewed can be chosen for synthesis.

23. The method of claim 19, wherein the content description comprises:
text-like descriptors from which at least spoken material can be synthesized;
photographic data from which video information can be synthesized;
style type alternatives from which a style of content to be viewed can be chosen for synthesis; and
a plurality of alternative flow specifications from which a version of the content to be viewed can be chosen for synthesis.

24. The method of claim 20, wherein the content description comprise a requirement for, prior to synthesis, gathering local information on the receiver end relating to one or more of:
desired length of presentation of at least two alternative versions;
a user mood appropriate for at least one of the plurality of versions;
a user location appropriate for at least one of the plurality of versions;
a desired content type;
a time of day appropriate to at least one of the plurality of versions;
a display device appropriate to at least one of the plurality of versions; and
a language in which at least one of a plurality of versions is presented;

25. Hardware for implementing the method of claims 19-24.
